(19) United States
(12) Patent Application Publication
(10) Pub. No.: US 2026/0167096 A1
(43) Pub. Date: Jun. 18, 2026

(54) METHOD FOR OPERATING AN OPERATING DEVICE FOR A MOTOR VEHICLE, CORRESPONDING OPERATING DEVICE FOR A MOTOR VEHICLE, AND COMPUTER PROGRAM PRODUCT

(71) Applicant: AUDI AG, Ingolstadt (DE)

(72) Inventors: Fabian ROTTE, Ingolstadt (DE); Florian BOCK, Schwaig (DE)

(73) Assignee: AUDI AG, Ingolstadt (DE)

(21) Appl. No.: 19/417,616

(22) Filed: Dec. 12, 2025

(30) Foreign Application Priority Data
Dec. 13, 2024 (DE) 102024137689.9

(51) Int. Cl. B60Q 1/50; B60Q 1/30

(52) U.S. Cl. CPC B60Q 1/50; B60Q 1/30; B60Q 2400/00

(57) ABSTRACT

A method for operating an operating device for a motor vehicle, including an environment detection device for detecting an operating action of a user in a triggering area present in an environment of the motor vehicle, and at least one illuminator for generating a light signal guiding the user towards the triggering area, wherein the illuminator is operated for generating the light signal when a presence of the user is detected. At least one illumination parameter used in generating the light signal is selected as a function of a variable quantity such that the light signal is generated with an illumination parameter corresponding to a first illumination parameter for a first value of the quantity and with an illumination parameter corresponding to a second illumination parameter for a second value of the quantity.

### FIELD

The invention relates to a method for operating an operating device for a motor vehicle, comprising an environment detection device for detecting an operating action of a user in a triggering area present in an environment of the motor vehicle, and at least one illuminating means for generating a light signal guiding the user towards the triggering area, wherein the illuminating means is operated for generating the light signal when a presence of the user is detected. The invention further relates to an operating device for a motor vehicle and a computer program product.

### BACKGROUND

Document DE 10 2014 116 171 A1, for example, is known from the prior art. The document describes a device for a motor vehicle, comprising: a sensor device having a housing, which is configured to be mountable to a first component of the motor vehicle in a predetermined first installation position and in which at least one sensor element is arranged, which, in the intended first installation position of the housing, has a detection range extending to a ground surface of an environment of the motor vehicle.

The sensor element is designed to generate a sensor signal dependent on the presence of an object, in particular a body part of a user, in the detection range. Furthermore, there is a light-emitting device which is designed to generate a light mark by radiating light in a part of the ground surface detected by the detection range. The light-emitting device is intended to be arranged outside the housing of the sensor device. The document also describes that the light is branched off from a beam path of a vehicle lamp by means of an optical element.

In addition, document DE 10 2014 017 354 B4 discloses a method for operating a taillight system of a motor vehicle, which system first comprises a first taillight assembly arranged in a tailgate and at least one second taillight assembly arranged in a body component adjacent to the tailgate, wherein the taillight system is operated depending on a pivoting position of the tailgate of the motor vehicle. The two taillight assemblies are to be actuated such that a light intensity of the two taillight assemblies is between a predetermined minimum value and maximum value both when the tailgate is open and when the tailgate is closed, wherein the first taillight assembly is supplied with a first electrical power when the tailgate is closed and with a second electrical power which is greater than the first electrical power when the tailgate is open.

### SUMMARY

It is an object of the invention to propose a method for operating an operating device for a motor vehicle, which method has advantages over known methods, in particular effectively guides the user towards the triggering area, such that the operating action of the user is detected extremely reliably.

This is achieved with a method for operating an operating device for a motor vehicle. At least one illumination parameter used in generating the light signal is selected as a function of a variable quantity such that the light signal is generated with an illumination parameter corresponding to a first illumination parameter for a first value of the quantity and with an illumination parameter corresponding to a second illumination parameter for a second value of the quantity.

Advantageous embodiments with expedient further developments of the invention are specified in the claims. It is pointed out that the exemplary embodiments explained in the description are not limiting; rather, any variations of the features disclosed in the description, the claims, and the figures can be implemented.

The method is used for operating the operating device for the motor vehicle. The operating device is preferably part of the motor vehicle, but can of course also be present separately therefrom, in particular until the operating device or the control device is mounted on or in the motor vehicle. The operating device is intended and designed to detect the operating action performed by the user in the triggering area and to perform an action, for example to actuate an actuator, depending on the detected operating action. Such a procedure is known in particular from an automatically unlockable and/or openable tailgate of the motor vehicle, in which the presence of a body part of the user, in particular a foot of the user, is checked in the triggering area. If the user's body part present in the triggering area is detected, the tailgate is automatically unlocked and/or opened.

The operating device has the illuminating means to indicate the triggering area to the user and guide the user in its direction. This at least temporarily generates the light signal, for example by projecting a light symbol onto a ground on which the motor vehicle is located. The light signal is generated such that the projection indicates to the user at which point the triggering area is located. The user can then carry out the operating action in the triggering area indicated by the light signal. Such a procedure admittedly allows the user to recognize where approximately the triggering area is located. However, the projection on the ground is often difficult to recognize or is so distorted by the ground that it no longer displays the triggering area correctly. In some cases, the user therefore finds it difficult to identify the triggering area quickly and efficiently despite the light signal.

For this reason, it is intended according to the invention to first check for the presence of the user, for example using the environment detection device. If the presence of the user is detected, that is, the environment detection device detects the user in the environment of the motor vehicle or in a defined sub-area of the environment, for example, the illuminating means is operated to generate the light signal. In other words, the illuminating means is activated to generate the light signal. The light signal is operated using the illumination parameter. With different values of the illumination parameter, different light signals or light signals which differ with respect to the illumination parameter are thus obtained. For example, the brightness of the illuminating means is used as the illumination parameter.

The illumination parameter is selected depending on the variable quantity, and is therefore present as a function of this variable quantity. The variable quantity is to be understood as a quantity which changes at least temporarily, such that the illumination parameter and thus the operation of the illuminating means also change accordingly. The light signal is to be generated continuously, that is, with an illumination parameter corresponding to the first illumination parameter for the first value of the quantity and with the illumination parameter corresponding to the second illumination parameter for the second value of the quantity.

The illuminating means is thus operated continuously to generate the light signal and the illuminating means is continuously activated, at least as long as the presence of the user is detected. However, the illuminating means is operated as a function of the variable quantity, such that the light signal changes at least temporarily. If the variable quantity has the first value, the first illumination parameter is used as the illumination parameter, and if the variable quantity has the second value, the second illumination parameter is used as the illumination parameter and the illuminating means is actuated or operated in accordance with the respective illumination parameter.

The procedure described does not expressly mean that the illuminating means is merely switched on and off depending on the variable quantity. Instead, the illuminating means is operated continuously to generate the illuminating means, that is, the light signal is generated continuously or is present continuously. However, at least one property of the light signal depends on the variable quantity. The property of the light signal is a property perceptible by the user, such that the user can recognize the value of the variable quantity on the basis of the light signal.

Specifically, the variable quantity is to be understood, for example, as a quantity which is continuous with time or as a time-dependent quantity. The value of the quantity changes with time, such that at different times the illuminating means is operated with different illumination parameters for generating the light signal, that is, it always generates the light signal. In this way, for example, an animation is implemented which guides the user towards the triggering area. It is conceivable, for example, that the illuminating means for generating the light signal is actuated at different points of the motor vehicle, in particular starting from a first point up to a second point. Accordingly, a type of running light is implemented which guides the user towards the second position, which is closer to the triggering area than the first position.

Alternatively, the variable quantity is, for example, the position of the user, such that the illuminating means is actuated as a function of the position for generating the light signal. Again, this does not expressly mean that the illuminating means is switched on and off depending on the position, but rather that the light signal is to be generated continuously with the aid of the illuminating means, but with different properties of the light signal which depend on the position of the user. With such a procedure, the user can be clearly signaled in which direction to move in order to reach the triggering area. Irrespective of the specific procedure, selecting the illumination parameter as a function of the variable quantity implements particularly effective guidance for the user when finding the detection area.

In a further development of the invention, an actuator of the operating device is actuated as a function of the detected operating action, in particular an actuator for automatically unlocking and/or for automatically opening a vehicle locking element of the motor vehicle. The operating action is, for example, merely arranging a body part in the detection range. As soon as the presence of the body part in the detection range is detected, the actuator is actuated to carry out a specific action. However, a more complex operating procedure may also be provided, for example, the presence of a certain gesture or the like is detected, in particular a certain sequence of movements which the user carries out.

The action carried out by the actuator is, for example, the automatic unlocking and/or the automatic opening of the vehicle locking element. The vehicle locking element is to be understood as an element which is arranged movably on the motor vehicle and which blocks or closes a vehicle opening of the motor vehicle to different extents in different positions. The vehicle locking element is present, for example, in the form of a tailgate, a vehicle door or the like. In any case, particularly convenient operation of the motor vehicle is implemented for the user.

In a further development of the invention, the availability of an authentication device is checked in order to detect the presence of the user. For example, the operating device checks whether a wireless connection to the authentication device can be established and/or whether the authentication device provides a suitable authentication feedback to an authentication request. The authentication device is, for example, a mobile part, in particular a vehicle key, which is preferably part of a keyless entry system of the motor vehicle. Such a procedure is extremely convenient for the user.

In a further development of the invention, a time variable or a position of the user determined using the environment detection device is used as the variable quantity. Such a procedure has already been discussed. In this respect, reference is made to the corresponding statements above. The environment detection device is used to detect the environment of the motor vehicle. When the environment is detected by means of the environment detection device, environment data is generated which describes the environment of the motor vehicle. To detect the environment or to provide the environment data, the environment detection device has an environment detection sensor or a plurality of environment detection sensors. One or more of the following sensors may be used as environment detection sensor(s), for example: radar sensor, sonar sensor, lidar sensor, image sensor or camera, and sound sensor or microphone.

The radar sensor uses electromagnetic waves, the sonar sensor uses sound waves, and the lidar sensor uses light to detect the environment, in particular to detect an obstacle present in the environment, which in this case corresponds at least temporarily to the user. The sonar sensor is designed as an ultrasonic sensor, for example, and consequently uses sound waves in the ultrasonic range. The radar sensor, the sonar sensor, and the lidar sensor are reflection sensors, that is, active sensors which emit an output signal into the environment and receive the reflected output signal again as an input signal. The sound sensor or the microphone is used to detect sound waves present in the environment.

A driver assistance device of the motor vehicle can carry out an assisted driving operation and/or an at least partially autonomous driving operation at least temporarily based on the environment data. This means that the surrounding data is evaluated, in particular with respect to one or more obstacles present in the vicinity of the motor vehicle. On this basis, in the case of assisted driving operation, supporting information is displayed to the user of the motor vehicle and, in the case of at least partially autonomous driving operation, the driving operation itself is carried out. Assisted driving operation or autonomous driving operation is carried out on the basis of obstacle data which describes obstacles present in the vicinity of the motor vehicle. Within the scope of the described method, the environment detection device is preferably used not only for carrying out the driving operation, but also for detecting the position of the user. This ensures particularly high accuracy of the detected position.

A further development of the invention provides that a taillight of the motor vehicle is used as the light source, which taillight is actuated during driving operation of the motor vehicle independently of the variable quantity as a function of an operating parameter of the motor vehicle. The taillight is arranged at the rear of the motor vehicle and radiates in particular to the rear, starting from the rear. If the driving operation of the motor vehicle is carried out, the motor vehicle is therefore, for example, in motion and/or if the motor vehicle is prepared for driving operation, for example by activating an operating device of the motor vehicle, the illuminating means is actuated temporarily independently of the variable quantity variable.

In this case, the illuminating means is actuated as a function of the operating parameter of the motor vehicle, for example as a function of a setting of an operating element of the motor vehicle. The control element is a light switch, a brake pedal or the like, for example. The taillight is therefore used in particular as a brake light and consequently has a corresponding brightness. The illuminating means is thus already present on the motor vehicle in any case; therefore no additional illuminating means is required on the motor vehicle for generating the light signal. Accordingly, this additional illuminating means can be eliminated.

In a further development of the invention, the illuminating means has a plurality of illuminating means segments which can be actuated independently of one another, wherein the illuminating means segments are actuated in each case as a function of a respective segment parameter contained in the illumination parameter, which is selected on the basis of the variable quantity. The illuminating means therefore does not only permit the brightness of the illuminating means as a whole to be adjusted, but the illuminating means segments can be operated independently of one another. For example, the illuminating means segments can be actuated in each case with respect to their brightness and/or their color. In this case, the illuminating means segments form a type of screen on which information can be displayed at a corresponding resolution.

In each case, the illumination parameter contains a corresponding segment parameter for each of the illuminating means segments of the illuminating means, and the illuminating means segments are actuated depending on their respective segment parameter. The segment parameters are selected depending on the variable quantity, as has already been explained for the illumination parameter. With such a procedure, particularly effective guidance of the user towards the triggering area is implemented.

In a further development of the invention, an illuminating means extending over at least 50%, at least 75% or at least 90% of a width of the motor vehicle is used as the illuminating means. The illuminating means is preferably not only present on one side of a longitudinal center plane of the motor vehicle, which receives both a longitudinal axis and a vertical axis of the motor vehicle and is perpendicular to a transverse axis of the motor vehicle. Instead, the illuminating means is present on both sides of this longitudinal center plane, in particular it is arranged symmetrically to the longitudinal center plane. It has an extension in the direction of the transverse axis which corresponds to at least 50%, at least 75% or at least 90% of the width of the motor vehicle in the same direction. The use of such an illuminating means enables precise guidance of the user, since the exact position of the triggering area in the direction of the transverse axis can be displayed to the user, for example.

In a further development of the invention, the illumination parameter, in particular based on the variable quantity, is determined as a function of time from a process specification, such that the light signal is present as a light signal animation. This has already been addressed. In any case, the illumination parameter is time-dependent and is determined based on the time from the process specification. A value of the illumination parameter is therefore stored in the process specification as a function of time. The light signal is thus generated such that it changes over time. Accordingly, it is present as a light signal animation. The illumination parameter is preferably determined not only as a function of time, but also taking into account the variable quantity, wherein the position of the user is preferably used as the variable quantity. This also serves to implement the advantages already explained.

In a further development of the invention, the illumination parameter is selected such that an absolute position of the triggering area and/or a relative position of the triggering area relative to the user is displayed to the user by means of the illuminating means. The absolute position and/or the relative position are to be understood in particular as positions in the direction of the transverse axis of the motor vehicle. The absolute position refers to the position of the triggering area on the motor vehicle, the relative position refers to the position of the user relative to the triggering area, or vice versa. The display of the absolute position immediately indicates to the user where the triggering area is located. When using the relative position, it is shown in which direction the user must move in order to reach the triggering range. In any case, efficient guidance of the user is implemented.

The invention further relates to an operating device for a motor vehicle, in particular for carrying out the method according to the statements within the scope of this description, wherein the operating device comprises an environment detection device for detecting an operating action of a user in a triggering area present in an environment of the motor vehicle, and at least one illuminating means for generating a light signal guiding the user towards the triggering area, wherein the illuminating means is intended and configured to operate the illuminating means for generating the light signal when a presence of the user is detected.

The operating device is in addition intended and configured to select the illumination parameter used in generating the light signal as a function of a variable quantity, such that the light signal is generated with an illumination parameter corresponding to a first illumination parameter for a first value of the quantity and with an illumination parameter corresponding to a second illumination parameter for a second value of the quantity.

The advantages of such a procedure or configuration of the operating device, respectively, have already been discussed. Both the operating device and the method for its operation can be developed further according to the statements within the scope of this description, to which reference will therefore be made.

In addition, the invention relates to a computer program product comprising commands which cause the operating device to carry out the method as explained according to the statements of this description. Regarding the advantages and possible advantageous further developments, reference should be made to the description as a whole.

The features and feature combinations described in the description, in particular the features and feature combinations described below in the description of the figures and/or shown in the figures may be used not only in the respective specified combination, but also in other combinations or alone, without departing from the scope of the invention, in particular within the scope of the claims. The invention should therefore also be considered to comprise embodiments that are not explicitly shown or explained in the description and/or the figures, but emerge from the explained embodiments or can be derived from them, in particular within the scope of the claims.

### BRIEF DESCRIPTION OF THE FIGURES

The invention will be explained below with reference to the exemplary embodiments shown in the drawings, without this limiting the invention. In particular, the only

FIG. 1 shows a schematic representation of a motor vehicle with an operating device.

### DETAILED DESCRIPTION

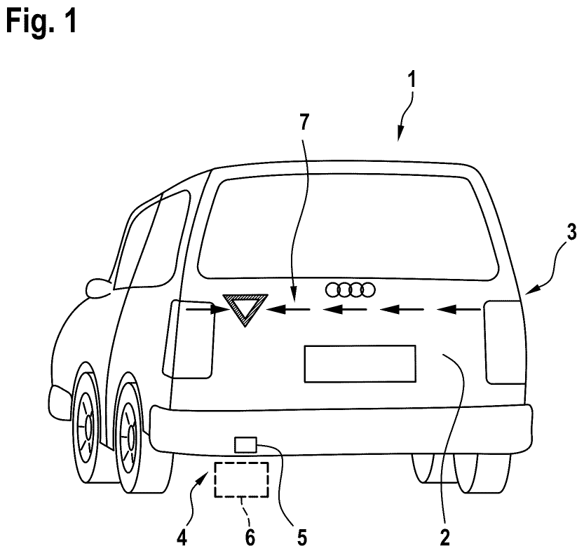

FIG. 1 shows a schematic representation of a motor vehicle 1. This comprises a vehicle locking element 2 which, in the embodiment shown, is designed as a tailgate of the motor vehicle 1. The motor vehicle 1 also comprises an operating device 3 which has an environment detection device 4, an environment detection sensor 5 of which is shown here. With the aid of the environment detection device 4, the presence of an operating action carried out by a user of the motor vehicle 1 is checked in a triggering area 6. The operating action is to be understood as meaning, for example, the arrangement of a body part of the user in, or movement thereof into, the triggering area 6.

In order to make it easier for the user to find the triggering area 6, the operating device 3 has an illuminating means 7 which is designed as a taillight in the exemplary embodiment shown. The environment detection device 4 is intended to be operated for detecting the presence of the user. For this purpose, the environment detection device can not only have the environment detection sensor 5, but the environment detection device also expressly contains a detection device for detecting the presence of the user, for example by checking the availability of an authentication device, for example a mobile part, in particular a key.

If the presence of the user is detected, the illuminating means 7 is operated to generate a light signal. This takes place according to an illumination parameter, that is, the light signal results as a function of the illumination parameter or a value of the illumination parameter. The illumination parameter is selected depending on a variable quantity that has different values over time. If there is a first value of the quantity, the light signal is generated with an illumination parameter that corresponds to a first illumination parameter. If, on the other hand, the quantity has the second value, a second illumination parameter is used as the illumination parameter.

The variable quantity is in particular a time quantity, that is, a variable quantity over time and/or a position of the user detected with the aid of the environment detection device 4. For example, the illuminating means 7 is operated to generate the light signal according to the pictograms shown. In particular, the light signal is present in the form of a plurality of arrows pointing towards a transverse axis to the triggering region 6. A triangular pictogram also indicates an absolute position of the triggering area 6 in the direction of the transverse axis on the motor vehicle 1.

With such a procedure, the user is very effectively guided towards the triggering area 6 so that the user can perform the operating action there, and this action is reliably detected.

### LIST OF REFERENCE NUMERALS

1 motor vehicle
2 vehicle locking element
3 operating device
4 environment detection device
5 environment detection sensor
6 triggering area
7 illuminating means

1. A method for operating an operating device for a motor vehicle, which has an environment detection device for detecting an operating action of a user in a triggering area present in an environment of the motor vehicle, and at least one illuminating means for generating a light signal which guides the user towards the triggering area, wherein the illuminating means is operated to generate the light signal upon detection of a presence of the user, wherein at least one illumination parameter used in the generation of the light signal is selected as a function of a variable quantity such that the light signal is generated at a first value of the quantity with an illumination parameter corresponding to a first illumination parameter and at a second value of the quantity with an illumination parameter corresponding to a second illumination parameter.

2. The method according to claim 1, wherein an actuator of the operating device is actuated as a function of the detected operating action.

3. The method according to claim 1, wherein a time variable or a position of the user determined using the environment detection device is used as the variable quantity.

4. The method according to claim 1, wherein a taillight of the motor vehicle is used as the illuminating means, which is actuated independently of the variable quantity as a function of an operating parameter of the motor vehicle during a driving operation of the motor vehicle.

5. The method according to claim 1, wherein the illuminating means has a plurality of illuminating means segments which can be actuated independently of one another, wherein the illuminating means segments are actuated in each case as a function of a respective segment parameter contained in the illumination parameter which is selected on the basis of the variable quantity.

6. The method according to claim 1, wherein an illuminating means extending over at least 50%, at least 75% or at least 90% of a width of the motor vehicle is used as the illuminating means.

7. The method according to claim 1, wherein the illumination parameter is determined as a function of time from a process specification, such that the light signal is present as a light signal animation.

8. The method according to claim 1, wherein the illumination parameter is selected such that an absolute position of the triggering area and/or a relative position of the triggering area relative to the user is displayed to the user by means of the illuminating means.

9. An operating device for a motor vehicle, in particular for carrying out the method according claim 1, wherein the operating device has an environment detection device for detecting an operating action of a user in a triggering area present in an environment of the motor vehicle, and at least one illuminating means for generating a light signal which guides the user towards the triggering area, wherein the operating device is intended and designed to operate the illuminating means to generate the light signal upon detection of a presence of the user wherein the operating device is intended and designed to select at least one illumination parameter used in the generation of the light signal as a function of a variable quantity, such that the light signal is generated at a first value of the quantity with an illumination parameter corresponding to a first illumination parameter and at a second value of the quantity with an illumination parameter corresponding to a second illumination parameter.

10. A computer program product comprising commands which cause an operating device to carry out the method according to claim 1.

11. The method according to claim 2, wherein a time variable or a position of the user determined using the environment detection device is used as the variable quantity.

12. The method according to claim 2, wherein a taillight of the motor vehicle is used as the illuminating means, which is actuated independently of the variable quantity as a function of an operating parameter of the motor vehicle during a driving operation of the motor vehicle.

13. The method according to claim 3, wherein a taillight of the motor vehicle is used as the illuminating means, which is actuated independently of the variable quantity as a function of an operating parameter of the motor vehicle during a driving operation of the motor vehicle.

14. The method according to claim 2, wherein the illuminating means has a plurality of illuminating means segments which can be actuated independently of one another, wherein the illuminating means segments are actuated in each case as a function of a respective segment parameter contained in the illumination parameter which is selected on the basis of the variable quantity.

15. The method according to claim 3, wherein the illuminating means has a plurality of illuminating means segments which can be actuated independently of one another, wherein the illuminating means segments are actuated in each case as a function of a respective segment parameter contained in the illumination parameter which is selected on the basis of the variable quantity.

16. The method according to claim 4, wherein the illuminating means has a plurality of illuminating means segments which can be actuated independently of one another, wherein the illuminating means segments are actuated in each case as a function of a respective segment parameter contained in the illumination parameter which is selected on the basis of the variable quantity.

17. The method according to claim 2, wherein an illuminating means extending over at least 50%, at least 75% or at least 90% of a width of the motor vehicle is used as the illuminating means.

18. The method according to claim 3, wherein an illuminating means extending over at least 50%, at least 75% or at least 90% of a width of the motor vehicle is used as the illuminating means.

19. The method according to claim 4, wherein an illuminating means extending over at least 50%, at least 75% or at least 90% of a width of the motor vehicle is used as the illuminating means.

20. The method according to claim 5, wherein an illuminating means extending over at least 50%, at least 75% or at least 90% of a width of the motor vehicle is used as the illuminating means.
